(19) United States
(12) Patent Application Publication
(10) Pub. No.: US 2026/0175646 A1
(43) Pub. Date: Jun. 25, 2026

(54) METHOD FOR STARTING THE COMBUSTION OPERATION OF A FUEL-POWERED VEHICLE HEATER

(71) Applicant: Eberspächer Climate Control Systems GmbH, Esslingen (DE)

(72) Inventor: Henry Rösch, Grafenau-Doeffingen (DE)

(21) Appl. No.: 19/427,657

(22) Filed: Dec. 19, 2025

(30) Foreign Application Priority Data
Dec. 19, 2024 (DE) 10 2024 138 809.9

(51) Int. Cl. B60H 1/22; F23N 3/00

(52) U.S. Cl. CPC B60H 1/2206; F23N 3/005; F23N 2227/02; F23N 2233/08; F23N 2241/14

(57) ABSTRACT

A method for starting the combustion operation of a vehicle heater includes: in an ignition phase after generating a start command, operating an air conveyer for conveying combustion air into the combustion chamber at an ignition phase speed, and operating a fuel conveyer for conveying fuel into the combustion chamber at an ignition phase delivery rate for providing an ignitable fuel/combustion air mixture; in a first speed adaptation phase, changing the speed of the combustion air conveyer to a flame stabilization phase speed which does not lead to the generation of a combustion resonance in the combustion chamber assembly; in a flame stabilization phase, operating the combustion air conveying device substantially at the stabilization phase speed; in a second speed adaptation phase, reducing the speed of the combustion air conveyer to a combustion operation speed; and, in combustion operation, operating the combustion air conveyer substantially at the combustion operation speed.

### CROSS-REFERENCE TO RELATED APPLICATIONS

This application claims priority of German patent application no. 10 2024 138 809.9, filed December 19, 2024, the entire content of which is incorporated herein by reference.

### TECHNICAL FIELD

The present disclosure relates to a method for starting the combustion operation of a fuel-powered vehicle heater.

### BACKGROUND

Fuel-powered vehicle heaters used as auxiliary heaters or independent vehicle heaters or interior heaters are started in that a combustion chamber of a combustion chamber assembly of such a vehicle heater is supplied with a predetermined magnitude of fuel and combustion air for the start phase in order to produce an ignitable mixture in the combustion chamber, in particular in the region of an ignition device, for example a glow plug. After the ignition of this mixture, a flame develops in the combustion chamber assembly. Until a stable combustion or a fully formed flame is achieved, locally unstable combustion states can occur, facilitated by thermal states in the combustion chamber assembly, in particular a comparatively low temperature of a flame tube, surrounding the forming flame, of the combustion chamber assembly, which locally unstable combustion states can lead to an acoustically clearly perceptible combustion resonance with corresponding excitation.

### SUMMARY

It is an object of the present disclosure to provide a method for starting the combustion operation of a fuel-powered vehicle heater, with which the occurrence of acoustically perceptible combustion states can be avoided in a start phase during the transition to combustion operation.

According to the disclosure, this object is achieved by a method for starting the combustion operation of a fuel-powered vehicle heater, the vehicle heater including:

a combustion chamber assembly to be supplied with fuel and combustion air,

a fuel conveying device for conveying fuel into a combustion chamber of the combustion chamber assembly,

a combustion air conveying device for conveying combustion air into the combustion chamber, wherein the combustion air conveying device includes at least one impeller wheel which can be driven to rotate for conveying combustion air.

A method according to the disclosure includes the following measures:

a) in an ignition phase after generating a start command for starting the combustion operation, operating the combustion air conveying device for conveying combustion air into the combustion chamber at an ignition phase speed assigned to the ignition phase, and operating the fuel conveying device for conveying fuel into the combustion chamber at an ignition phase delivery rate assigned to the ignition phase for providing an ignitable fuel/combustion air mixture,

b) in a first speed adaptation phase following the ignition phase, changing the speed of the combustion air conveying device to a flame stabilization phase speed which does not lead to the generation of a combustion resonance in the combustion chamber assembly,

c) in a flame stabilization phase following the first speed adaptation phase, operating the combustion air conveying device substantially at the flame stabilization phase speed,

d) in a second speed adaptation phase following the flame stabilization phase, reducing the speed of the combustion air conveying device to an combustion operation speed,

e) in combustion operation following the second speed adaptation phase, operating the combustion air conveying device substantially at the combustion operation speed.

In the method, following the ignition phase and thus shortly after the ignition of the mixture of fuel and combustion air formed in the combustion chamber, changing the speed of the combustion air conveying device ensures that a excitation frequency of the combustion air conveying device substantially determined by the speed of the combustion air conveying device and the configuration of the impeller wheel of the combustion air conveying device, in particular the number of conveying blades of the impeller wheel, has a value which is not in the range of a resonance frequency of the combustion occurring in the combustion chamber or a flame tube connected thereto of the combustion chamber assembly for forming the flame. Depending on the configuration of a vehicle heater and also depending on ambient conditions, such a resonance frequency can be in the range of 70-80 Hz.

The excitation of acoustically clearly perceptible combustion resonances in the combustion chamber assembly in a phase, in which it is not yet at operating temperature and therefore thermally unstable conditions are present, in particular in the surrounding area of the combustion chamber assembly, can thus be avoided. At the same time, in this phase of the formation of a stable combustion, the flame-surrounding region of the combustion chamber assembly, in particular the flame tube thereof, can be brought to operating temperature. When this state is reached, a thermal interaction between the flame and, for example, the flame tube cannot generally lead to the emergence of combustion resonances, even when the excitation frequency of the combustion air conveying device lies in a fundamentally critical value range with regard to the excitation of combustion resonances.

In order to be able to ensure, by changing the speed of the combustion air conveying device, that firstly the excitation of combustion resonances and secondly the emission of an excessive pollutant content or of unburnt fuel is avoided, it is proposed that, in measure b), in order to provide the flame stabilization phase speed which does not lead to the generation of a combustion resonance in the combustion chamber assembly, the speed of the combustion air conveying device, starting from the ignition phase speed, is increased in such a way that, in measure c), a substoichiometric mixture of fuel and combustion air is produced in the combustion chamber.

In particular, it can be provided here that, in measure b), the speed of the combustion air conveying device is increased in such a way that the mixture of fuel and combustion air produced in the combustion chamber has a lambda value of less than 0.8. It has been shown that such a low lambda value of this type causes such a high delivery rate and thus also such a high speed of the combustion air conveying device that periodic pressure variations generated by the rotation of the impeller wheel of the combustion air conveying device in the conveyed air and also propagating into the region of the combustion chamber cannot lead to the excitation of a combustion resonance.

In order to achieve an ignition as quickly as possible after the start command has been generated, the ignition phase speed and the ignition phase delivery rate can be set, in measure a), for providing a fuel/combustion air mixture that is substantially stoichiometric, for example also slightly superstoichiometric.

In order to achieve a substantially uniform transition between states of different speed of the combustion air conveying device, it is proposed that, in measure b), the speed is increased at a substantially constant speed change rate, and/or that, in measure d), the speed is reduced at a substantially constant speed change rate.

In order to reach an operating phase, in which the flame can be stabilized, as quickly as possible, it is proposed that, in measure b), the speed is increased at a maximum first magnitude of the speed change rate, that, in measure d), the speed is reduced at a maximum second magnitude of the speed change rate, and that the maximum first magnitude is greater than the maximum second magnitude.

Here, particularly preferably, the maximum first magnitude of the change rate corresponds substantially to a maximum adjustable speed change rate in the combustion air conveying device for increasing the speed. This means that the structural and also actuation-technical possibilities for rapidly increasing the speed of the combustion air conveying device or at least one impeller wheel thereof are exploited as far as possible, without introducing the risk of damaging system regions, in particular the combustion air conveying device. The maximum adjustable speed change rate can be defined or limited, for example, by the maximum voltage which can be applied to an electric motor of the combustion air conveying device, that is, is provided by an on-board voltage network or by the maximum permissible operating voltage or average operating voltage for such an electric motor. In the case of electrically commutated motors, the speed can be changed via voltage control. Such a rapid change in the speed of the combustion air conveying device ensures that an excitation frequency range, in which a resonance frequency of combustion pulsations of the forming flame also lies, is passed through very quickly and thus the emergence of combustion resonances can be avoided.

A rapid transition into the flame stabilization phase can also be assisted by the fact that a duration of the ignition phase lies in the range from 2 s to 4 s, preferably at approximately 3 s.

In order to be able to take the ambient conditions into account in the flame stabilization, it can be provided that a duration of the flame stabilization phase is set as a function of an ambient temperature and/or a temperature in the region of the combustion chamber assembly. Advantageously, the duration of the flame stabilization phase increases here with a decreasing ambient temperature and/or a temperature in the region of the combustion chamber assembly.

In order to ensure that a substoichiometric mixture of fuel and combustion air is produced in the flame stabilization phase, a fuel delivery rate in the first speed adaptation phase and the flame stabilization phase can correspond substantially to the ignition phase delivery rate.

At the transition into the combustion operation following the start phase, the fuel delivery rate can be set to a combustion operation delivery rate provided for combustion operation in the second speed adaptation phase. If the setpoint heating output of the vehicle heater specified for the subsequent combustion operation requires a greater quantity of fuel, the fuel delivery rate can be increased accordingly in the second speed adaptation phase. If, for example, a vehicle heater can only be operated in a single heating power stage and, accordingly, for example, the fuel delivery device can only be switched off and on, but cannot be substantially varied in its delivery quantity, the combustion operation delivery rate provided for the subsequent combustion operation can correspond to the previously set ignition phase delivery rate, for example, with the result that setting the fuel delivery rate to the rate provided for the subsequent combustion operation includes substantially maintaining the previously used fuel delivery rate.

### BRIEF DESCRIPTION OF DRAWINGS

The invention will now be described with reference to the drawings wherein:

FIG. 1 shows an outline illustration of a fuel-powered vehicle heater; and,

FIG. 2 shows a time diagram showing an example of the change in the fuel quantity or combustion air quantity conveyed in a start phase of the combustion operation of a fuel-powered vehicle heater.

### DETAILED DESCRIPTION

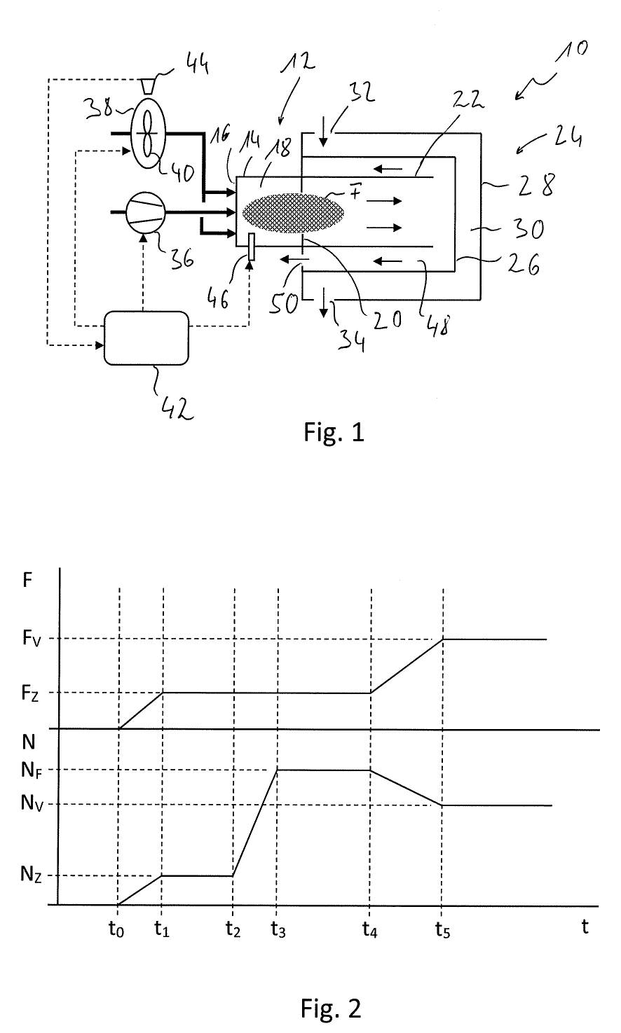

FIG. 1 shows a fuel-powered vehicle heater 10 in outline. The vehicle heater 10 includes, as a central assembly, a combustion chamber assembly 12 with a combustion chamber 22, bordered by a peripheral wall 14 and a bottom wall 16, and a flame tube 18 which, for example, adjoins the peripheral wall 14 in the region of a flame shield 20.

The combustion chamber 12 is at least partially surrounded by a heat exchanger assembly 24 with a heat transfer medium flow space 30 delimited by a pot-like inner housing 26 and a pot-like outer housing 28. At a heat transfer medium inlet 32, liquid medium to be heated can enter the heat transfer medium flow space 30, flow through it for heat absorption and leave again at a heat transfer medium outlet 34. It should be noted that, in the event that the vehicle heater 10 is configured for heating a gaseous heat transfer medium, for example the air to be introduced into a vehicle interior, the combustion chamber 12 can be arranged in a housing which can be flowed through by the air to be heated.

For the production of heat, a liquid fuel taken from a tank is fed into the combustion chamber 18 via a fuel conveying device 36 which is configured, for example, as a dosing pump. If the combustion chamber assembly 12 is configured as an evaporator burner, the liquid fuel can be fed, for example, into a porous evaporator medium and discharged via this in gaseous form into the combustion chamber 18. When configured as an atomizer burner, the liquid fuel can be supplied to an atomizer nozzle, via which the fuel is discharged in the form of an atomized spray into the combustion chamber 18.

In order to provide the oxygen required for combustion, combustion air is fed into the combustion chamber 18 via a combustion air conveying device 38 which is configured, for example, as a side channel blower. The combustion air conveying device 38 includes an impeller wheel 40 which is rotatable for conveying the combustion air and is generally driven by an electric motor for rotation.

The fuel conveying device 36 and the combustion air conveying device 38 are actuated by an actuating unit 42. This can be supplied, for example, by a speed sensor 44 assigned to the combustion air conveying device 38 with information about the speed of the impeller wheel 40 of the combustion air conveying device 38, and, taking into account this actual speed, the actuating unit 42 can actuate the combustion air conveying device 38 in such a way that the impeller wheel 40 thereof rotates at a setpoint speed defined for a specified operation. As an alternative to such a controlled operation of the combustion air conveying device 38, it can be operated in a controlled operation by applying a voltage or average voltage assigned to a setpoint speed of the impeller wheel 40.

The fuel conveying device 36 is also actuated by the actuating device 42 and can be actuated, in particular in the configuration as a dosing pump, for setting the fuel quantity to be fed into the combustion chamber 18 in such a way that the fuel conveying device 36 is operated at such a clock frequency assigned to a setpoint fuel quantity of this type which is predetermined for operation.

In order to ignite a mixture of fuel and combustion air present or forming in the combustion chamber 18, the combustion chamber assembly 12 has an ignition device 46 formed, for example, as an auto-ignition pin. This is also actuated by the actuating unit 42, with the result that, at the start of the combustion operation of the vehicle heater 10 for igniting the mixture of fuel and combustion air formed or formed in the combustion chamber 18, the actuating unit 42 actuates the ignition device 46 and excites it for generating a temperature sufficient for igniting the mixture.

In the following text, with reference to FIG. 2, a method is described, by way of which the vehicle heater 10 can be operated in a start phase for starting the combustion operation.

At a time t₀, a start command for starting the operation of the vehicle heater 10 with a start phase leading to a continuous combustion operation is generated by the actuating unit 42 or another system region of a vehicle. After generating or supplying the start command, the actuating unit 42 sets the conveying devices 36, 38 which are initially in an out-of-operating condition into operation, with the result that, in an ignition phase following the time t₀ up to a time t₁, the speed N of the combustion air conveying device 38 or the impeller wheel 40 of the same is increased at a, for example, substantially constant speed change rate up to an ignition speed N_{Z} and is maintained at this speed until the end of the ignition phase at a time t₂.

In conjunction with the starting up of the combustion air conveying device 38 and the increase in the speed N of the impeller wheel 40, the fuel conveying device 36 is also put into operation and its fuel delivery rate F, for example, is substantially constantly increased to an ignition phase delivery rate F_{Z} which is assigned to the ignition phase speed N_{Z}. In order to provide a mixture of combustion air and fuel during the entire ignition phase, which mixture corresponds substantially to the ratio to be provided for the ignition phase, the fuel delivery rate F can be increased concurrently with the speed N, with the result that the ignition phase delivery rate F_{Z} is substantially also achieved at the time t₁ and then, for the remaining period of the ignition phase, combustion air and fuel are continuously supplied at the mixture ratio to be provided for the ignition phase, for example substantially a stoichiometric ratio, that is, for a lambda value of 1. For the ignition phase, this ratio can also slightly deviate from a lambda value of 1, for example in the direction of a superstoichiometric ratio or, if necessary, a substoichiometric ratio. Depending on the configuration type of vehicle heater 10, the ignition phase speed N_{Z} and the ignition phase delivery rate F_{Z} can also be achieved at different times.

The ignition phase lying between the times t₀ and t₂ can be configured, for example, in such a way that it lasts approximately 3 s, with the result that, in the course of this ignition phase, firstly the flammable mixture of fuel and combustion air can be generated at the quantity ratio provided for the ignition phase and secondly the ignition can also take place in this ignition phase by exciting the ignition device 46. This means that combustion already starts in the ignition phase in the combustion chamber 18 and a flame F begins to form.

Following the ignition phase, in a first speed adaptation phase from the time t₂ to a time t₃, the speed N and thus the delivery rate of the combustion air conveying device 38 is greatly increased. It is preferably provided that, in the first speed change phase, the speed N is increased at a maximum adjustable speed change rate in the combustion air conveying device 28. This maximum adjustable speed change rate can be limited, for example, by the maximum available on-board power supply voltage in an on-board voltage network of a vehicle, which voltage is applied in this state continuously, that is, with a duty ratio of 100%, to an electric motor of the speed conveyor device 38. If, for example, this on-board power supply voltage is higher than the voltage that may be applied to the electric motor of the combustion air conveying device 38 as a maximum, the maximum adjustable speed change rate can be limited by the maximum voltage or average voltage that can be used for the combustion air conveying device 38, which can be adjusted by specifying a correspondingly limited duty cycle for the voltage applied to the electric motor of the combustion air conveying device 38.

In the first speed adaptation phase, the speed N is raised to a flame stabilization phase speed N_{F} assigned to a flame stabilization phase following from the time t₃ at, for example, a substantially constant speed change rate. In the flame stabilization phase, the flame stabilization phase speed N_{F}, for example, is maintained substantially constant until a time t₄.

By rapidly increasing the speed N of the combustion air conveying device 38 to the flame stabilization phase speed N_{F}, which is significantly higher than the ignition phase speed N_{Z}, it is achieved that an excitation frequency of the combustion air conveying device 38 in the flame stabilization phase is significantly higher than a resonance frequency of combustion anomalies in the forming flame F. If such combustion anomalies are excited at an excitation frequency in the range of their resonance frequency, acoustically perceptible combustion resonances can arise in the combustion chamber assembly 12, in particular when the surroundings of the combustion, in particular the peripheral wall 14 or the flame tube 22, are not yet at operating temperature and a thermal interaction of the resulting flame with these system regions promotes the emergence of anomalies in the combustion.

The excitation of such oscillations in the combustion, which in the unfavorable case lead to a combustion resonance, can be carried out by periodic pressure pulsations which are generated in the region of the combustion air conveying device 38 by the rotation of the impeller wheel 40 and can continue in the combustion air into the region of the combustion chamber 18 or the forming flame F. The frequency of such periodic pressure pulsations generated by the rotation of the impeller wheel 40 can be substantially determined by the product of the speed of the impeller wheel 40 and the number of conveying blades thereof. For example, in the case of a configuration of the combustion air conveying device 38 as a side channel blower, the conveying blades of the impeller wheel thereof move during each rotation of the impeller wheel over an interrupting region which disconnects an inlet and an outlet of an annular channel of the side channel blower, wherein every movement of a conveying blade over this interrupting region can lead to a pressure variation propagating in the conveyed combustion air.

By rapidly increasing the speed N of the combustion air conveying device 38 or the impeller wheel 40 thereof to the flame stabilization phase speed N_{Z}, not only is the excitation frequency range, in which there is potentially the risk of the formation of combustion resonances, rapidly passed through, but also a greatly substoichiometric mixture of fuel and combustion air is produced and burnt in the combustion chamber 18 following the flame stabilization phase. Firstly, this ensures that the introduced fuel can be completely burnt even in the flame stabilization phase, and secondly assists rapid heating of the combustion chamber assembly 12, in particular the flame tube 22, to an operating temperature which, even with thermal interaction between the flame F and, for example, the flame tube 22, does not lead to the formation of anomalies in the combustion promoting combustion resonances. It has been shown that an increase in the speed N of the combustion air conveying device 38 in such a way that the mixture of fuel and combustion air then formed in the combustion chamber 18 has a lambda value of less than 0.8, causes such a high speed and thus a high excitation frequency of the combustion air conveying device 38 that, even with a flame or combustion that has not yet stabilized, the excitation of combustion resonances does not occur.

The speed of the combustion air conveying device 38 or the excitation frequency or an excitation frequency range, in which there is the risk of the formation of combustion resonances in the vehicle heater 10, can be determined, for example, in an assembled vehicle heater, in particular also taking into account different ambient conditions, by virtue of the fact that, in a start phase, the speed of the combustion air conveying device 38 is varied in such a way that combustion resonances actually occur. If this critical speed or a critical speed range is known, the flame stabilization phase speed N_{F} can also be selected or predetermined in association with various ambient conditions in such a way that there is a sufficient safety margin from a speed that promotes the emergence of combustion resonances.

Since the formation and stabilization of the flame F also greatly depends on environmental conditions such as, for example, the fuel temperature, the temperature of the combustion air introduced into the combustion chamber 18, the temperature in the region of the combustion chamber 12 itself, the humidity and the air pressure, the duration of the flame stabilization phase, that is, the interval between the time points t₃ and t₄, can be set depending on such ambient conditions, in particular the ambient temperature or the temperature in the region of the combustion chamber itself. These temperatures can be detected, for example, by corresponding sensors, and the output signals of these sensors can be used in the actuating unit 42 for setting the time duration of the flame stabilization phase. It can be provided that, at a decreasing ambient air temperature or temperature in the region of the combustion chamber assembly 12, the duration of the flame stabilization phase increases. It has been shown that, for example, when the temperature in the surroundings of the vehicle heater 10 and thus, for example, also the temperature of the combustion chamber assembly 12 is at room temperature, that is, about 20°C, the duration of the flame stabilization phase should lie in a range of 40-50 seconds, in order to promote stable combustion, in particular even by sufficiently heating the combustion chamber assembly itself. If the temperature in the surroundings of the combustion chamber assembly 12, which then substantially also corresponds to the temperature of the combustion air introduced into the combustion chamber 18 or the temperature of the combustion chamber assembly 12, in particular the flame tube 22, is about -40°C, it can be necessary to have a duration of the flame stabilization phase in the range of several minutes to stabilize the combustion.

At the end of the flame stabilization phase at time t₄, in a second speed adaptation phase up to a time t₅, the speed N of the combustion air conveying device 38 or of the impeller wheel 40 is reduced at a speed change rate, the magnitude of which is smaller than the magnitude of the speed change rate in the first speed adaptation phase between the time points t₂ and t₃. Concomitant with this reduction of the speed N to a specified combustion operating speed N_{V} for a subsequent combustion operation from the time t₅ in association with a heating output which is then also set, for example, depending on ambient conditions or a temperature of a medium to be heated, for example in the the second speed adaptation phase, the delivery rate F of the fuel conveying device 36 is also increased to a combustion operation to be carried out subsequently or the combustion operation delivery rate F_{V} assigned to this heating power, if the required heating output requires a quantity of fuel that is greater than the quantity of fuel delivered into the combustion chamber 18 by operating the fuel conveying device 36 at the ignition phase delivery rate F_{Z}. If the quantity of fuel conveyed in the ignition phase is also sufficient for the subsequent combustion operation or the vehicle heater 10 can in principle only be operated with a single heating output stage, in the transition from the flame stabilization phase into the combustion operation, this means that the fuel delivery rate F remains substantially unchanged between the time points t₄and t₅.

The combustion operation speed N_{V} and the combustion operation delivery rate F_{V} are fundamentally dimensioned in such a way that, for the combustion operation carried out from time t₅, the quantity of the mixture of combustion air and fuel provided for setting the required heating output is provided at a mixture ratio provided for combustion operation, for example a stoichiometric or slightly substoichiometric mixture ratio.

By way of the procedure described above, the vehicle heater 10 can be transferred into combustion operation in a cold start or else a restart, for example after a loss of flame, without combustion resonances acoustically perceptible outside the vehicle heater 10 arising during the formation of the flame F. At the same time, operation with a greatly substoichiometric mixture of fuel and combustion air ensures that substantially no unburnt fuel escapes from the combustion chamber assembly 12 and, together with the combustion exhaust gas already formed during the formation of the flame F, leaves an exhaust gas flow space 48 formed between the flame tube 22 and the heat exchanger assembly 24 in the direction of an exhaust gas outlet 50.

The method according to the disclosure can differ in various aspects from the procedure described above and shown in FIG. 2. Thus, for example, in at least one of the speed adaptation phases, the speed N of the combustion air conveying device 38 can be changed at a changing speed change rate, with the result that a maximum speed change rate is present at times in each case in one or both speed change phases. At a constant speed change rate, this corresponds to the maximum speed change rate in a respective speed adaptation phase.

In the ignition phase and/or the flame stabilization phase, it can be provided, in a deviation from the substantially constant speeds N or fuel delivery rates F shown, that the speed N and/or the fuel delivery rate F remain/remains approximately at the level shown, but varies slightly in this range, for example. For example, it can be provided that, from the time t₁ or the time t₂ the fuel delivery rate F increases approximately constantly at a comparatively low change rate, for example until time t₅, with the result that, without further adaptation measures, the fuel is fed into the combustion chamber 18 from time t₅ at the combustion operation delivery rate F_{V} to be provided for the combustion operation to then be carried out.

It is understood that the foregoing description is that of the preferred embodiments of the invention and that various changes and modifications may be made thereto without departing from the spirit and scope of the invention as defined in the appended claims.

1. A method for starting the combustion operation of a fuel-powered vehicle heater, the vehicle heater including a combustion chamber assembly to be supplied with fuel and combustion air, a fuel conveying device for conveying fuel into a combustion chamber of the combustion chamber assembly, a combustion air conveying device for conveying combustion air into the combustion chamber, wherein the combustion air conveying device includes at least one impeller wheel configured to be driven for rotation for conveying combustion air, the method comprising:
a) in an ignition phase after generating a start command for starting the combustion operation, operating the combustion air conveying device for conveying combustion air into the combustion chamber at an ignition phase speed assigned to the ignition phase, and operating the fuel conveying device for conveying fuel into the combustion chamber at an ignition phase delivery rate assigned to the ignition phase for providing an ignitable fuel/combustion air mixture;
b) in a first speed adaptation phase following the ignition phase, changing a speed of the combustion air conveying device to a flame stabilization phase speed which does not lead to the generation of a combustion resonance in the combustion chamber assembly;
c) in a flame stabilization phase following the first speed adaptation phase, operating the combustion air conveying device at the flame stabilization phase speed;
d) in a second speed adaptation phase following the flame stabilization phase, reducing the speed of the combustion air conveying device to a combustion operation speed; and,
e) in combustion operation following the second speed adaptation phase, operating the combustion air conveying device at the combustion operation speed.

2. The method of claim 1, wherein, in b) for providing the flame stabilization phase speed which does not lead to generating a combustion resonance in the combustion chamber assembly, the speed of the combustion air conveying device is increased, starting from the ignition phase speed, such that, in measure c), a substoichiometric mixture of fuel and combustion air is produced in the combustion chamber.

3. The method of claim 2, wherein, in b), the speed of the combustion air conveying device is increased such that the mixture of fuel and combustion air produced in the combustion chamber has a lambda value of less than 0.8.

4. The method of claim 1, wherein, in a), the ignition phase speed and the ignition phase delivery rate are set to provide a stoichiometric fuel/combustion air mixture.

5. The method of claim 1, wherein at least one of:
in b), the speed is increased at a constant speed change rate; and,
in d), the speed is reduced at a constant speed change rate.

6. The method of claim 1, wherein, in b), the speed is increased at a maximum first magnitude of the speed change rate; in d), the speed is reduced at a maximum second magnitude of the speed change rate; and, the maximum first magnitude is greater than the maximum second magnitude.

7. The method of claim 6, wherein the maximum first magnitude of the speed change rate corresponds to a maximum adjustable speed change rate in the combustion air conveying device for increasing the speed.

8. The method of claim 1, wherein a duration of the ignition phase lies in a range from 2 seconds to 4 seconds.

9. The method of claim 1, wherein a duration of the ignition phase is 3 seconds.

10. The method of claim 1, wherein a duration of the flame stabilization phase is set as a function of at least one of an ambient temperature and a temperature in a region of the combustion chamber assembly.

11. The method of claim 10, wherein the duration of the flame stabilization phase increases with at least one of the ambient temperature decreasing and the temperature in the region of the combustion chamber assembly decreasing.

12. The method of claim 1, wherein a fuel delivery rate in the first speed adaptation phase and the flame stabilization phase corresponds to the ignition phase delivery rate.

13. The method of claim 1, wherein, in the second speed adaptation phase, the fuel delivery rate is set to a combustion operation delivery rate provided for combustion operation.
